(19) United States
(12) Patent Application Publication
(10) Pub. No.: US 2012/0186550 A1
(43) Pub. Date: Jul. 26, 2012

(54) DEVICE FOR STARTING AN INTERNAL COMBUSTION ENGINE HAVING A REDUCED NUMBER OF CONTROL LINES

(76) Inventors: Simon Rentschler, Changshu (CN); Sven Hartmann, Stuttgart (DE)

(21) Appl. No.: 13/388,602

(22) PCT Filed: Jul. 8, 2010
(86) PCT No.: PCT/EP2010/059836

§ 371 Date: Apr. 13, 2012

(30) Foreign Application Priority Data
Sep. 9, 2009 (JP) 102009029288.8

(51) Int. Cl. F02N 11/08

(52) U.S. Cl. 123/179.1

(57) ABSTRACT

A device for starting an internal combustion engine is described. This device has a control unit, a drive pinion, a starter motor, and multiple relays, which are connected via control lines to the control unit. At least one of the control lines is connected to multiple relays.

### FIELD OF THE INVENTION

The present invention relates to a device for starting an internal combustion engine having a reduced number of control lines.

### BACKGROUND INFORMATION

Drives, which are powered by a power source independent of the fuel supply, are used for starting internal combustion engines. DC motors are typically used, whose drive pinion first engages in a gear ring of the internal combustion engine, in order to drive the internal combustion engine thereafter. After the end of the starting procedure, the drive pinion disengages again from the gear ring of the internal combustion engine. A shared relay is used for the engagement procedure and the through-connection of the main current to drive the DC motor. An associated schematic circuit diagram is shown in FIG. 1. It shows a relay 1, which is connected to a terminal 50, a switch 2, a control unit 5, terminal 30 of the motor vehicle, and a starter motor M. Control unit 5 has a driver TR0, to which a switching signal S₀₀ is applied. When the driver is switched through, relay 1 is connected via a control line SL0 and terminal 50 to a positive operating voltage +. Relay 1 is then energized and closes switch 2. Starter motor M is connected to terminal 30 of the motor vehicle by the closing of switch 2 and is thus put into operation.

A starting device for starting an internal combustion engine is described in European Patent No. EP 0 848 159 B1, which has a starter motor, which is connectable via a starter relay to a voltage source and may be engaged with the internal combustion engine to crank it. Furthermore, an electronic control unit is provided to activate the starter relay and/or the starter motor. It activates semiconductor power end stages, which are assigned to the starter relay and/or the starter motor, in such a way that at least during start-stop operation of the internal combustion engine, the starter relay has its engaged position in the stopped state of the internal combustion engine. In this starting device, the starter relay is energized after a starting switch is operated, so that, on the one hand, a contact is closed which connects the starter motor to a supply voltage and, on the other hand, independently thereof, the pinion of the starter motor engages in a gear ring situated on a crankshaft of the internal combustion engine.

A starting system for an internal combustion engine as well as a method for operating a starting system are described in German Patent No. DE 100 05 005 A1. This starting system includes a starter pinion which may engage in a motor shaft of the internal combustion engine via a gear ring of the motor, an electronically switchable electric motor which transfers a torque to the starter pinion during a starting procedure of the internal combustion engine, an electronically switchable actuator operating which may cause at least the pinion to engage in the gear ring of the motor (engaging phase) or the same component to decouple (free-running phase), and a sensor system using which a continuation of the starting procedure is detected. During the starting procedure, the electric motor and the actuator are controlled with the aid of a control unit based on the signals provided by the sensor system.

A device for activating an electromagnetic switching element, in particular a relay, is described in German Patent Application No. DE 10 2009 000 125.5, in which the time which elapses between the triggering of the energization and the energization and also the time which elapses between the triggering of the de-energization and the de-energization is reduced. Such a relay may be used in connection with start-stop systems based on pinion starters. Three control lines are provided to activate such a relay, via which a control unit operates switching elements, which allow or block a current flow through two coils of the relay, which may be energized independently of one another, as a function of their switch position.

Increasing prevalence of motor vehicles having a start-stop functionality on the market is connected to expanded requirements on the starting system of the motor vehicle and also to an expansion of the functions. In particular, the starting capability of the vehicle must be ensured upon every starting request of the driver. Furthermore, it must be ensured that no or only slight voltage drops occur during the starting. The requirement results therefrom to already engage the starter in a synchronized manner in the gear ring during coasting of the internal combustion engine and to limit the starting current of the starter. This may be achieved by feeding the main current for the starter motor to the starter motor, on the one hand, via a series resistor and, on the other hand, directly with a time delay. This makes a separation of the functionalities of a typical starter relay necessary. An approach in this regard is to provide a first relay for the engagement of the drive pinion and to use two additional relays in order to feed the main current for the starter motor, on the one hand, via a series resistor and, on the other hand, directly to the DC motor with a time delay. Such a separation of the relay functionality and the necessity resulting therefrom of using three relays, namely a solenoid switch, a starting current relay, and a main current relay, has the result that up to three control lines are required per relay. In contrast to relay controllers in which a single control line is sufficient, this causes substantial additional expenditure in the wiring and control of the relay.

### SUMMARY

An example device for starting an internal combustion engine in accordance with the present invention may have the advantage that the number of the required control lines is reduced. The number of the required drivers is thus also decreased. The outlay which must be made in connection with the wiring and the control is also reduced by this decrease of the number of the control lines and the drivers. These advantages are generally achieved by a multiple usage of control lines.

### BRIEF DESCRIPTION OF THE DRAWINGS

FIG. 1 shows a schematic circuit diagram of a shared relay for engagement and through connection of a main current to drive a DC motor.

FIG. 2a shows an exemplary embodiment of a low-side device.

FIG. 2b shows an exemplary embodiment of a low-side device having an interconnection according to the present invention.

FIG. 3a shows an exemplary embodiment of a high-side device.

FIG. 3b shows an exemplary embodiment of a high-side device having an interconnection according to the present invention.

FIG. 4 shows an exemplary embodiment of a low-side device according to the present invention having a solenoid switch.

FIG. 5a shows an exemplary embodiment of a low-side device according to the present invention without a starting current relay.

FIG. 5b shows an exemplary embodiment of a high-side device according to the present invention without a starting current relay.

FIG. 6 shows a further exemplary embodiment of a low-side device having an interconnection according to the present invention.

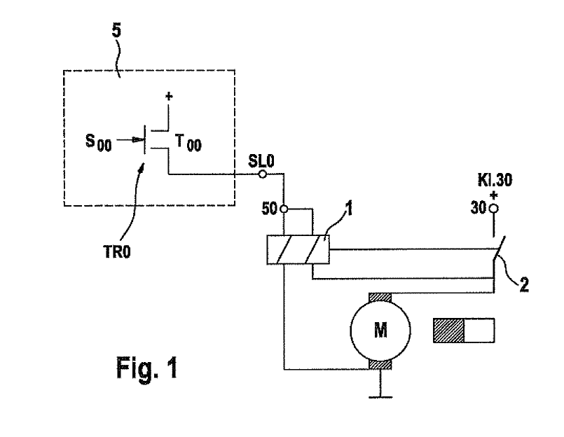

### DETAILED DESCRIPTION OF EXAMPLE EMBODIMENTS

A device for starting an internal combustion engine according to the present invention has a control unit, a drive pinion, a starter motor, and multiple relays, which are connected via control lines to the control unit. At least one control line is connected to multiple relays. This has the advantage that in comparison to known devices, the number of the control lines of the device is reduced. As explained below on the basis of the figures, this has the result that the number of drivers required by the device is also decreased.

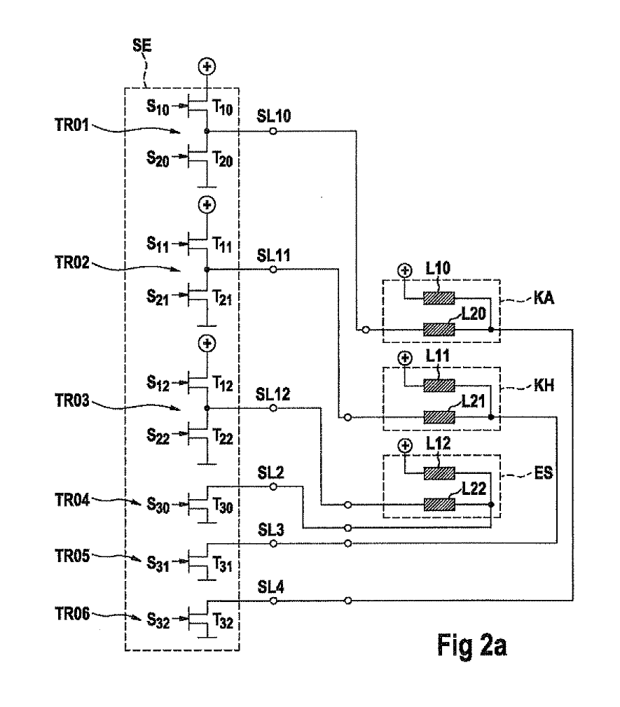

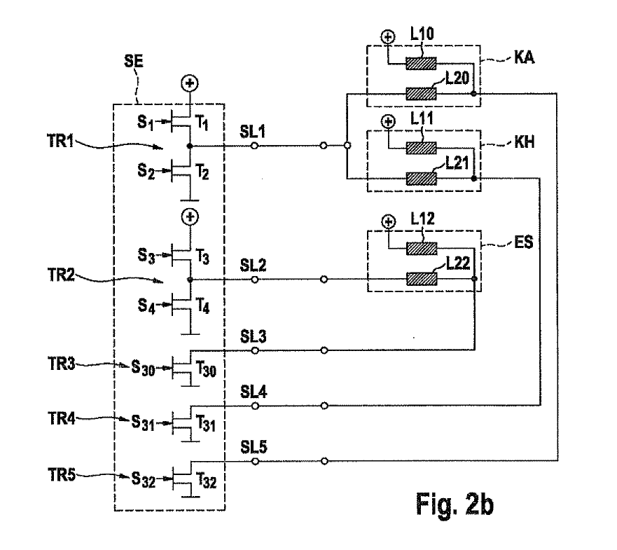

FIG. 2a shows an exemplary embodiment of a low-side device for starting an internal combustion engine and FIG. 2b shows an exemplary embodiment of a low-side device having an interconnection according to the present invention.

The example device shown in FIG. 2a has a starting current relay KA, a main current relay KH, and a solenoid switch ES. Starting current relay KA has a holding winding L10 and an engagement winding L20. Main current relay KH contains a holding winding L11 and an engagement winding L21. Solenoid switch ES includes a holding winding L12 and an engagement winding L22. One terminal of the particular holding winding is connected to a positive operating voltage terminal. The other terminal of the particular holding winding is connected to one terminal of the particular associated engagement winding. The particular other terminal of the engagement windings is connected in each case via a control line to control unit SE. The other terminal of engagement winding L20 of starting current relay KA is thus connected to control unit SE via control line SL10. The other terminal of engagement winding L21 of main current relay KH is connected via control line SL11 to control unit SE. The other terminal of engagement winding L22 of solenoid switch ES is connected to control unit SE via control line SL12.

The connection point between holding winding L10 and engagement winding L20 of starting current relay KA is connected via a control line SL4 to control unit SE. The connection point between holding winding L11 and engagement winding L21 of main current relay KH is connected via a control line SL3 to control unit SE. The connection point between holding winding L12 and engagement winding L22 of solenoid switch ES is connected via a control line SL2 to control unit SE.

Control unit SE, which provides control signals for relays KA, KH, and ES on above-mentioned control lines SLID, SL11, SL12, SL2, SL3, and SL4, has drivers TR01, TR02, TR03, TR04, TR05, and TR06. Driver transistors T₁₀ and T₂₀, whose breaks are connected in series between a positive operating voltage terminal + and ground, are associated with driver TR01. A switching signal S₁₀ is applied to driver transistor T₁₀, and a switching signal S₂₀ is applied to driver transistor T₂₀. The connection point between the two driver transistors T₁₀ and T₂₀ is connected to control line SLID.

Driver transistors T₁₁ and T₂₁, whose breaks are connected in series between positive operating voltage terminal + and ground, are associated with driver TR02. A switching signal S₁₁ is applied to driver transistor T₁₁, and a switching signal S₂₁ is applied to driver transistor T₂₁. The connection point between the two driver transistors T₁₁ and T₂₁ is connected to control line SL11.

Driver transistors T₁₂ and T₂₂, whose breaks are connected in series between positive operating voltage terminal + and ground, are associated with driver TR03. A switching signal S₁₂ is applied to driver transistor T₁₂, and a switching signal S₂₂ is applied to driver transistor T₂₂. The connection point between the two driver transistors T₁₂ and T₂₂ is connected to control line SL12.

A driver transistor T₃₀, to which a switching signal S₃₀ is applied, is associated with driver TR04. Control line SL2 is connected to ground via the break of this driver transistor.

A driver transistor T₃₁, to which a switching signal S₃₁ is applied, is associated with driver TR05. Control line SL3 is connected to ground via the break of this driver transistor.

A driver transistor T₃₂, to which a switching signal S₃₂ is applied, is associated with driver TR06. Control line SL4 is connected to ground via the break of this driver transistor. In the device shown in FIG. 2a, each of relays KA, KH, and ES has three connection lines. One of these connection lines leads to a positive operating voltage source (not shown). The two other connection lines each lead to control unit SE and are control lines. As a result, the device in FIG. 2a uses a total of six control lines and also six drivers.

An exemplary embodiment of a low-side device having an interconnection according to the present invention is shown in FIG. 2b. This device requires only five control lines and only five drivers.

The device shown in FIG. 2b has a starting current relay KA, a main current relay KH, and a solenoid switch ES. Starting current relay KA has a holding winding L10 and an engagement winding L20. Main current relay KH contains a holding winding L11 and an engagement winding L21. Solenoid switch ES includes a holding winding L12 and an engagement winding L22. One terminal of the particular holding winding is connected to a positive operating voltage terminal +. The other terminal of the particular, holding winding is connected to one terminal of the particular associated engagement winding. The particular other terminal of engagement windings L20 of starting current relay KA and L21 of main current relay KH is connected via a shared control line SL1 to control unit SE. The other terminal of engagement winding L22 of solenoid switch ES is connected via a control line SL2 to the control unit SE.

The connection point between holding winding L10 and engagement winding L20 of starting current relay KA is connected via a control line SL5 to control unit SE. The connection point between holding winding L11 and engagement winding L21 of main current relay KH is connected via a control line SL4 to control unit SE. The connection point between holding winding L12 and engagement winding L22 of solenoid switch ES is connected via a control line SL3 to control unit SE.

Control unit SE, which provides control signals for relays KA, KH, and ES on above-mentioned control lines SL1, SL2, SL3, SL4, and SL5, has drivers TR1, TR2, TR3, TR4, and TR5. Driver transistors T₁ and T₂, whose breaks are connected in series between a positive operating voltage terminal + and ground, are associated with driver TR1. A switching signal S₁ is applied to driver transistor T₁, and a switching signal S₂ is applied to driver transistor T₂. The connection point between the two driver transistors T₁ and T₂ is connected to control line SL1.

Driver transistors T₃ and T₄, whose breaks are connected in series between positive operating voltage terminal + and ground, are associated with driver TR2. A switching signal S₃ is applied to driver transistor T₃, and a switching signal S₄ is applied to driver transistor T₄. The connection point between the two driver transistors T₃ and T₄ is connected to control line SL2.

A driver transistor T₃₀, to which a switching signal S₃₀ is applied, is associated with driver TR3. Control line SL3 is connected to ground via the break of this driver transistor.

A driver transistor T₃₁, to which a switching signal S₃₁ is applied, is associated with driver TR4. Control line SL4 is connected to ground via the break of this driver transistor. A driver transistor T₃₂, to which a switching signal S₃₂ is applied, is associated with driver TR5. Control line SL5 is connected to ground via the break of this driver transistor.

In the device shown in FIG. 2b, each of relays KA, KH, and ES also has three connection lines. One of these connection lines leads to a positive operating voltage source (not shown). The two other connection lines each lead to control unit SE and are control lines.

Control line SL1 is a shared control line for starting current relay KA and main current relay KH. Holding winding L20 of starting current relay KA and also holding winding L21 of main current relay KH are connected via this control line SL1 to control unit SE. Control line SL1 is therefore assigned to both starting current relay KA and also main current relay KH. As a result, the device shown in FIG. 2b only requires a total of five control lines and—as is apparent from the illustration in FIG. 2b—also only five drivers. As a result, through the optimized interconnection shown in FIG. 2b, one control line and one driver are saved in comparison to the device shown in FIG. 2a. This decreases the outlay arising due to the wiring, reduces the costs, and saves space.

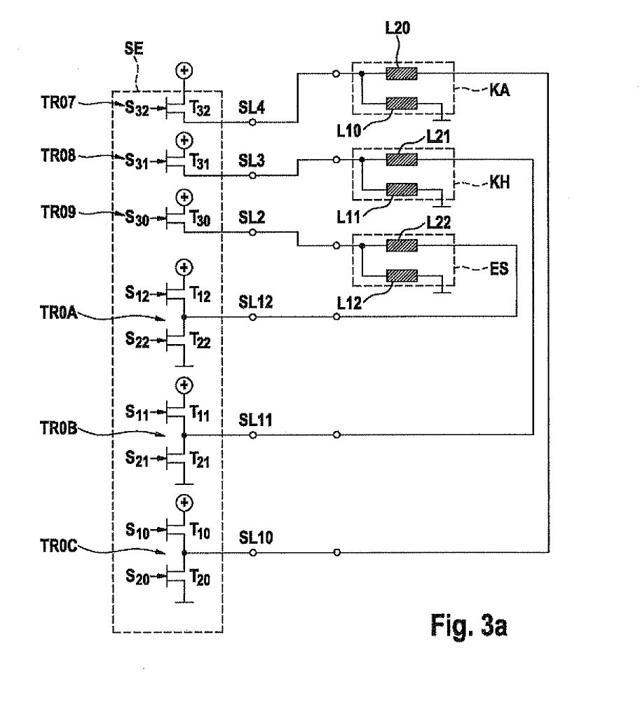

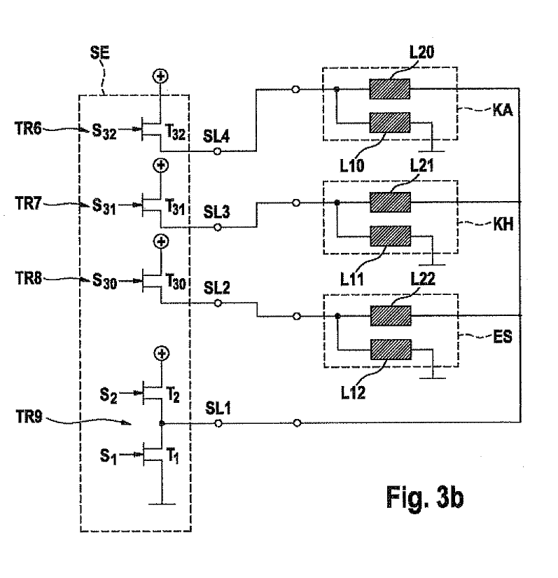

FIG. 3a shows an exemplary embodiment of a high-side device for starting an internal combustion engine and FIG. 3b shows an exemplary embodiment of a high-side device having an interconnection according to the present invention.

The device shown in FIG. 3a has a starting current relay KA, a main current relay KH, and a solenoid switch ES. Starting current relay KA has an engagement winding L20 and a holding winding L10. Main current relay KH contains an engagement winding L21 and a holding winding L11. Solenoid switch ES includes an engagement winding L22 and a holding winding L12. One terminal of the particular holding winding is connected to ground. The other terminal of the particular holding winding is connected to one terminal of the particular associated engagement winding. Furthermore, the other terminal of the particular holding winding is connected in each case via a control line to control unit SE. Therefore, the other terminal of holding winding L10 of starting current relay KA is connected to control unit SE via a control line SL4. The other terminal of holding winding L11 of main current relay KH is connected via control line SL3 to control unit SE. The other terminal of holding winding L12 of solenoid switch ES is connected to control unit SE via control line SL2.

The other terminal of engagement winding L20 of starting current relay KA is connected via a control line SL10 to control unit SE. The other terminal of engagement winding L21 of main current relay KH is connected via a control line SL11 to control unit SE. The other terminal of engagement winding L22 of solenoid switch ES is connected via a control line SL12 to control unit SE.

Control unit SE, which provides control signals for relays KA, KH, and ES on above-mentioned control lines SL2, SL3, SL4, SL10, SL11, and SL12, has drivers TR07, TR08, TR09, TR0A, TR0B, and TR0C. Driver transistors T₁₂ and T₂₂, whose breaks are connected in series between a positive operating voltage terminal + and ground, are associated with driver TR0A. A switching signal S₁₂ is applied to driver transistor T₁₂, and a switching signal S₂₂ is applied to driver transistor T₂₂. The connection point between the two driver transistors T₁₂ and T₂₂ is connected to control line SL12.

Driver transistors T₁₁ and T₂₁, whose breaks are connected in series between positive operating voltage terminal + and ground, are associated with driver TR0B. A switching signal S₁₁ is applied to driver transistor T₁₁, and a switching signal S₂₁ is applied to driver transistor T₂₁. The connection point between the two driver transistors T₁₁ and T₂₁ is connected to control line SL11.

Driver transistors T₁₀ and T₂₀, whose breaks are connected in series between positive operating voltage terminal + and ground, are associated with driver TR0C. A switching signal S₁₀ is applied to driver transistor T₁₀, and a switching signal S₂₀ is applied to driver transistor T₂₀. The connection point between the two driver transistors T₁₀ and T₂₀ is connected to control line SL10.

A driver transistor T₃₂, to which a switching signal S₃₂ is applied, is associated with driver TR07. Control line SL4 is connected to positive operating voltage + via the break of this driver transistor.

A driver transistor T₃₁, to which a switching signal S₃₁ is applied, is associated with driver TR08. Control line SL3 is connected to positive operating voltage + via the break of this driver transistor.

A driver transistor T₃₀, to which a switching signal S₃₀ is applied, is associated with driver TR09. Control line SL2 is connected to positive operating voltage + via the break of this driver transistor.

In the device shown in FIG. 3a, each of relays KA, KH, and ES has three connection lines. One of these connection lines leads to ground. The two other connection lines each lead to control unit SE and are control lines. The device shown in FIG. 3a therefore uses a total of six control lines and also six drivers.

An exemplary embodiment of a high-side device having an interconnection according to the present invention is shown in FIG. 3b. This device requires only four control lines and also only four drivers.

The device shown in FIG. 3b has a starting current relay KA, a main current relay KH, and a solenoid switch ES. Starting current relay KA has a holding winding L10 and an engagement winding L20. Solenoid switch ES contains a holding winding L12 and an engagement winding L22. Main current relay KH includes a holding winding L11 and an engagement winding L21. One terminal of the particular holding winding is connected to ground. The other terminal of the particular holding winding is connected to one terminal of the particular associated engagement winding and is connected via a particular associated control line to control unit SE. The particular other terminal of engagement windings L20, L21, and L22 is connected via a shared control line SL1 to control unit SE.

Control unit SE, which provides control signals for relays KA, KH, and ES on above-mentioned control lines SL1, SL2, SL3, and SL4, has drivers TR6, TR7, TR8, and TR9. Driver transistors T₂ and T₁, whose breaks are connected in series between a positive operating voltage terminal and ground, are associated with driver TR9. A switching signal S₁ is applied to driver transistor T₁, and a switching signal S₂ is applied to driver transistor T₂. The connection point between the two driver transistors T₂ and T₁ is connected to control line SL1.

A driver transistor T₃₂, to which a switching signal S₃₂ is applied, is associated with driver TR6. Control line SL4 is connected to positive operating voltage + via the break of this driver transistor.

A driver transistor T₃₁, to which a switching signal S₃₁ is applied, is associated with driver TR7. Control line SL3 is connected to positive operating voltage + via the break of this driver transistor.

A driver transistor T₃₀, to which a switching signal S₃₀ is applied, is associated with driver TR8. Control line SL2 is connected to positive operating voltage + via the break of this driver transistor.

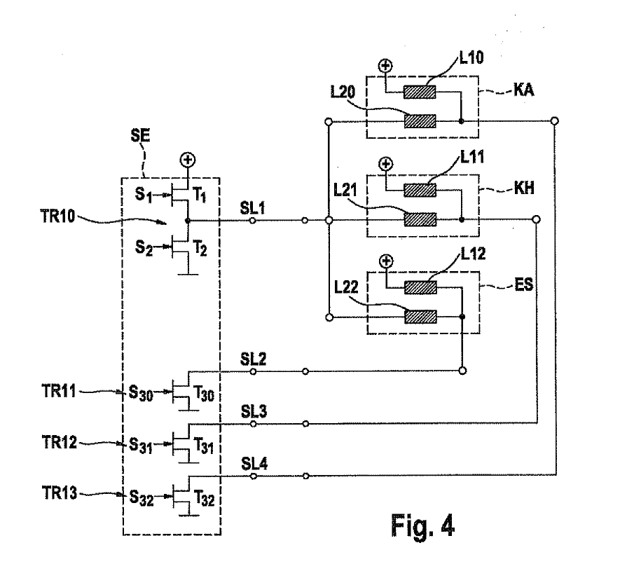

In the device in FIG. 3b, each of relays KA, KH, and ES has three connection lines. One of these connection lines leads to ground. The two other connection lines each lead to control unit SE and are control lines. Control line SL1 is a shared control line for starting current relay KA, main current relay KH, and solenoid switch ES. Engagement winding L20 of starting current relay KA, engagement winding L21 of main current relay KH, and engagement winding L22 of solenoid switch ES are connected to control unit SE via this control line SL1. Control line SL1 is therefore assigned to starting current relay KA and also main current relay KH and also solenoid switch ES. As a result, the device in FIG. 3b requires only a total of four control lines and—as is apparent from the illustration in FIG. 3b—also only four drivers. As a result, through the optimized interconnection shown in FIG. 3b, two control lines and two drivers are saved in comparison to the device shown in FIG. 3a. This decreases the outlay arising due to the wiring, reduces the costs, and saves space. FIG. 4 shows an exemplary embodiment of a low-side device according to the present invention having a solenoid switch. The device shown in FIG. 4 has a starting current relay KA, a main current relay KH, and a solenoid switch ES. Starting current relay KA has a holding winding L10 and an engagement winding L20. Main current relay KH contains a holding winding L11 and an engagement winding L21. Solenoid switch ES includes a holding winding L12 and an engagement winding L22. One terminal of the particular holding winding is connected to a positive operating voltage terminal +. The other terminal of the particular holding winding is connected to one terminal of the particular associated engagement winding. The particular other terminal of engagement windings L20 of starting current relay KA, L21 of main current relay KH, and L22 of solenoid switch ES is connected via a shared control line SL1 to control unit SE.

The connection point between holding winding L10 and engagement winding L20 of starting current relay KA is connected via a control line SL4 to control unit SE. The connection point between holding winding L11 and engagement winding L21 of main current relay KH is connected via a control line SL3 to control unit SE. The connection point between holding winding L12 and engagement winding L22 of solenoid switch ES is connected via a control line SL2 to control unit SE.

Control unit SE, which provides control signals for relays KA, KH, and ES on above-mentioned control lines SL1, SL2, SL3, and SL4, has drivers TR10, TR11, TR12, and TR13. Driver transistors T₁ and T₂, whose breaks are connected in series between a positive operating voltage terminal + and ground, are associated with driver TR10. A switching signal S₁ is applied to driver transistor T₁, and a switching signal S₂ is applied to driver transistor T₂. The connection point between the two driver transistors T₁ and T₂ is connected to control line SL1.

A driver transistor T₃₀, to which a switching signal S₃₀ is applied, is associated with driver TR11. Control line SL2 is connected to ground via the break of this driver transistor.

A driver transistor T₃₁, to which a switching signal S₃₁ is applied, is associated with driver TR12. Control line SL3 is connected to ground via the break of this driver transistor.

A driver transistor T₃₂, to which a switching signal S₃₂ is applied, is associated with driver TR13. Control line SL4 is connected to ground via the break of this driver transistor.

In the device shown in FIG. 4, each of relays KA, KH, and ES also has three connection lines. One of these connection lines leads to a positive operating voltage source (not shown). The two other connection lines each lead to control unit SE and are control lines. Control line SL1 is a shared control line for starting current relay KA, main current relay KH, and solenoid switch ES. Engagement winding L20 of starting current relay KA, engagement winding L21 of main current relay KH, and engagement winding L22 of solenoid switch ES are connected to control unit SE via this control line SL1. Control line SL1 is therefore assigned to both starting current relay KA and also main current relay KH and also solenoid switch ES. As a result, the device shown in FIG. 4 requires only a total of four control lines and—as is apparent from the illustration in FIG. 4—also only four drivers.

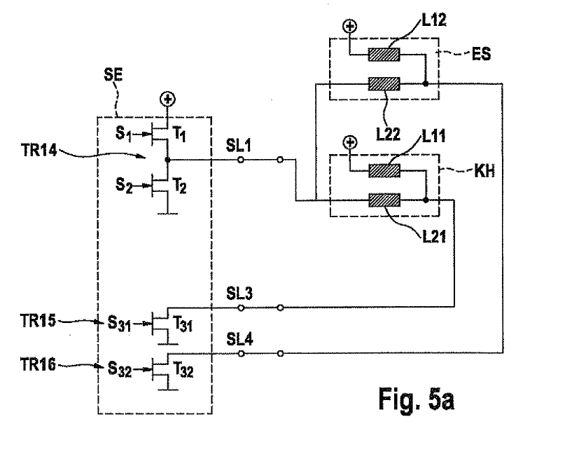

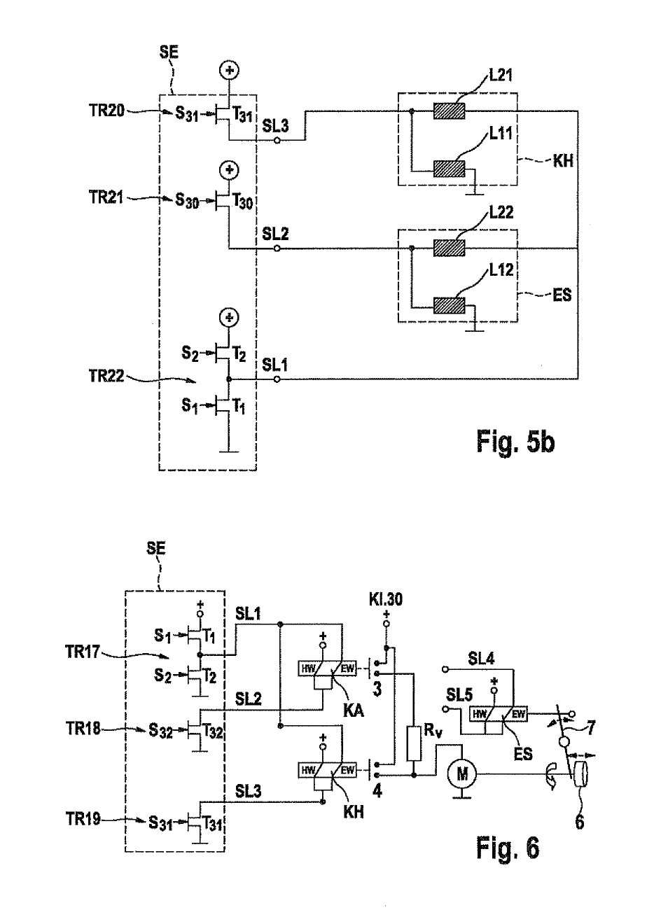

The device shown in FIG. 5a is a low-side device and has an solenoid switch ES and a main current relay KH. Solenoid switch ES has a holding winding L12 and an engagement winding L22. Main current relay KH contains a holding winding L11 and an engagement winding L21. One terminal of the particular holding winding is connected to a positive operating voltage terminal +. The other terminal of the particular holding winding is connected to one terminal of the particular associated engagement winding. The particular other terminal of engagement windings L22 of solenoid switch ES and L21 of main current relay KH are connected via a shared control line SL1 to control unit SE.

The connection point between holding winding L12 and engagement winding L22 of solenoid switch ES is connected via a control line SL4 to control unit SE. The connection point between holding winding L11 and engagement winding L21 of main current relay KH is connected via a control line SL3 to control unit SE.

Control unit SE, which provides control signals for relays ES and KH on above-mentioned control lines SL1, SL3, and SL4, has drivers TR14, TR15, and TR16. Driver transistors T₁ and T₂, whose breaks are connected in series between a positive operating voltage terminal and ground, are associated with driver TR14. A switching signal S₁ is applied to driver transistor T₁, and a switching signal S₂ is applied to driver transistor T₂. The connection point between the two driver transistors T₁ and T₂ is connected to control line SL1.

A driver transistor T₃₁, to which a switching signal S₃₁ is applied, is associated with driver TR15. Control line SL3 is connected to ground via the break of this driver transistor. A driver transistor T₃₂, to which a switching signal S₃₂ is applied, is associated with driver TRIG. Control line SL4 is connected to ground via the break of this driver transistor.

In the device shown in FIG. 5a, each of relays ES and KH has three connection lines. One of these connection lines leads to a positive operating voltage source (not shown). The two other connection lines each lead to control unit SE and are control lines. Control line SL1 is a shared control line for solenoid switch ES and main current relay KH. Engagement winding L22 of solenoid switch ES and also engagement winding L21 of main current relay KH are connected to control unit SE via this control line SL1. Control line SL1 is therefore assigned to both solenoid switch ES and also main current relay KH. As a result, the device shown in FIG. 5a requires only a total of three control lines and—as also shown in FIG. 5a—also only three drivers.

The device shown in FIG. 5b is a high-side device and has a solenoid switch ES and a main current relay KH. Solenoid switch ES has a holding winding L12 and an engagement winding L22. Main current relay contains a holding winding L11 and an engagement winding L21. One terminal of the particular holding winding is connected to ground. The other terminal of the particular holding winding is connected to one terminal of the particular associated engagement winding. The particular other terminal of engagement windings L22 of solenoid switch ES and L21 of main current relay KH is connected via a shared control line SL1 to control unit SE.

The connection point between holding winding L12 and engagement winding L22 of solenoid switch ES is connected via a control line SL2 to control unit SE. The connection point between holding winding L11 and engagement winding L21 of main current relay KH is connected via a control line SL3 to control unit SE.

Control unit SE, which provides control signals for relays ES and KH on above-mentioned control lines SL1, SL2, and SL3, has drivers TR20, TR21, and TR22. A driver transistor T₃₁, to which a switching signal S₃₁ is applied, is associated with driver TR20. Control line SL3 is connected to positive operating voltage terminal + via the break of this driver transistor T₃₁. A driver transistor T₃₀, to which a switching signal S₃₀ is applied, is associated with driver TR21. Control line SL2 is connected to positive operating voltage terminal + via the break of this driver T₃₀. Driver transistors T₁ and T₂ are associated with driver TR22. Control line SL1 is connected to positive operating voltage terminal + via the break of driver transistor T₂. Control line SL1 is connected to ground via the break of driver transistor T₁. A switching signal S₁ is applied to driver transistor T₁, and a switching signal S₂ is applied to driver transistor T₂.

In the device shown in FIG. 5b, each of relays ES and KH has three connection lines. One of these connection lines leads to ground. The two other connection lines each lead to control unit SE and are control lines. Control line SL1 is a shared control line for solenoid switch ES and main current relay KH. Engagement winding L22 of solenoid switch ES and also engagement winding L21 of main current relay KH are connected to control unit SE via this control line SL1. Control line SL1 is therefore assigned to both solenoid switch ES and also main current relay KH. As a result, the device shown in FIG. 5b requires only three control lines and—as shown in FIG. 5b—also only three drivers.

FIG. 6 shows a further exemplary embodiment of a low-side device having an interconnection according to the present invention, the entire device for starting an internal combustion engine being shown in greater detail than in the preceding figures.

The device shown in FIG. 6 has a starting current relay KA, a main current relay KH, and a solenoid switch ES. Starting current relay KA has a holding winding HW and an engagement winding EW. Main current relay KH also contains a holding winding HW and an engagement winding EW. Solenoid switch ES also includes a holding winding HW and an engagement winding EW. One terminal of the particular holding winding is connected to a positive operating voltage terminal +. The other terminal of particular holding winding HW is connected to one terminal of the particular associated engagement winding EW. The particular other terminal of the engagement windings of starting current relay KA and main current relay KH is connected via a shared control line SL1 to control unit SE. The other terminal of engagement winding EW of solenoid switch ES is connected via a control line SL4 to control unit SE.

The connection point between holding winding HW and engagement winding EW of starting current relay KA is connected via a control line SL2 to control unit SE. The connection point between holding winding HW and engagement winding EW of main current relay KH is connected via a control line SL3 to control unit SE. The connection point between holding winding HW and engagement winding EW of solenoid switch ES is connected via a control line SL5 to control unit SE.

Control unit SE, which provides control signals for relays KA, KH, and ES on above-mentioned control lines SL1, SL2, SL3, SL4, and SL5, has drivers TR17, TR18, TR19 and two further drivers (not shown), the two drivers which are not shown being connected to control lines SL4 and SL5.

Driver transistors T₁ and T₂, whose breaks are connected in series between a positive operating voltage terminal + and ground, are associated with driver TR17. A switching signal S₁ is applied to driver transistor T₁, and a switching signal S₂ is applied to driver transistor T₂. The connection point between the two driver transistors T₁ and T₂ is connected to control line SL1.

A driver transistor T₃₂, to which a switching signal S₃₂ is applied, is associated with driver TR18. Control line SL2 is connected to ground via the break of this driver transistor.

A driver transistor T₃₁, to which a switching signal S₃₁ is applied, is associated with driver TR19. Control line SL3 is connected to ground via the break of this driver transistor.

To start the internal combustion engine (not shown in FIG. 6), control unit SE first activates solenoid switch ES via control line SL4. This has the result that engagement lever 7 is operated and drive pinion 6 engages in a gear ring (not shown) of the crankshaft of the internal combustion engine. This may occur, as described in European Patent No. EP 0 848 159 B1, in the end phase of a stopping procedure within the scope of a start-stop operation of a motor vehicle, or only at the beginning of the starting procedure following a stopping procedure. Control unit SE then outputs a control signal via control line SL1, which is supplied to starting current relay KA and main current relay KH. Control unit SE subsequently first switches through switching transistor T₃₂ with the aid of switching signal S₃₂ and, with a time delay thereto, switching transistor T₃₁ with the aid of switching signal S₃₁. This has the result that starting current relay KA is initially energized and closes switch 3. Operating voltage +, which is present at terminal 30 of the motor vehicle, is thus applied via closed switch 3 and series resistor R_{V} to starter motor M, so that it starts softly. Switch 4 is then closed with a time delay by energizing main current relay KH. This has the result that starter motor M is now connected via closed switch 4 to terminal 30 and receives the current required to drive pinion 6. The gear ring fastened to the crankshaft of the motor vehicle is driven via pinion 6 and the motor vehicle or the internal combustion engine is thus started.

Since control line SL1 is connected to both starting current relay KA and also main current relay KH in this exemplary embodiment and since only one driver of the control unit is assigned to control line SL1, the number of required control lines and the number of required drivers is also reduced in this exemplary embodiment.

1-9. (canceled)

10. A device for starting an internal combustion engine, comprising:
a control unit including a plurality of drivers;
a drive pinion;
a starter motor coupled to the drive pinion, the control unit to control the starter motor; and
multiple relays connected via control lines to the control unit, each of the control lines being connected in each case to one of the drivers, each of the relays having a holding winding and an engagement winding, each of the relays having three connection lines, two of the connection lines leading to the control unit and a third of the connection lines leading to one of a positive operating voltage source or to ground, and at least one of the control lines being connected to a plurality of the relays.

11. The device as recited in claim 10, wherein the device is a low-side device, each of the at least one control line which is connected to the plurality of the relays being connected in each case to one terminal of the engagement winding of one of the plurality of relays, a particular other terminal of the engagement winding is connected to one terminal of the holding winding, and a particular other terminal of the holding winding is connected to the positive operating voltage source.

12. The device as recited in claim 10, wherein the device is a high-side device, each of the at least one control line which is connected to the plurality of the relays being connected in each case to one terminal of the engagement winding of one of the plurality of relays, a particular other terminal of the engagement winding is connected to one terminal of the holding winding, and a particular other terminal of the holding winding is connected to ground.

13. The device as recited in claim 10, further comprising a solenoid switch and a main current relay.

14. The device as recited in claim 13, wherein the device has a shared control line for the solenoid switch and the main current relay.

15. The device as recited in claim 10, wherein the device has a solenoid switch, a starting current relay, and a main current relay.

16. The device as recited in claim 15, wherein the device has a shared control line for the starting current relay and the main current relay.

17. The device as recited in claim 15, wherein the device has a shared control line for the starting current relay and the solenoid switch.

18. The device as recited in claim 15, wherein the device has a shared control line for the solenoid switch and the main current relay.

19. The device as recited in claim 10, wherein the device has a shared control line for the solenoid switch, the starting current relay, and the main current relay.
